(19) United States
(12) Patent Application Publication
(10) Pub. No.: US 2013/0206544 A1
(43) Pub. Date: Aug. 15, 2013

(54) Apparatus And Method For Placing Rows And/Or Piles Of Packaged Units Onto Transport Pallets

(71) Applicant: Eckhard Polman, Hunxe (DE)

(72) Inventor: Eckhard Polman, Hunxe (DE)

(21) Appl. No.: 13/876,085

(22) PCT Filed: Sep. 27, 2011
(86) PCT No.: PCT/EP2011/004821

§ 371 Date: May 3, 2013

(30) Foreign Application Priority Data
Sep. 27, 2010 (DE) 20 2010 013 608.3

(51) Int. Cl. B65G 57/00

(52) U.S. Cl. CPC B65G 57/00
USPC 198/431

(57) ABSTRACT

A palletising device for populating transport pallets (1) with packaging units (2) in rows and/or stacks in at least one layer (A1) of packaging units (2), having a feed apparatus (3) for bringing the packaging units into the vicinity of the transport pallet (1) and having a delivery apparatus (5) for providing a transport pallet (1) with the packaging units (2) brought. In order to make continuous palletising possible with a generic palletising device, it is proposed that the delivery apparatus (5) comprises an endless conveying means (5A), which comprises at least two conveyor runs (T1, T2, T3, . . . ) acting as transport legs (T) in a horizontal arrangement and the horizontally arranged endless conveying means (5A) as a whole can be moved by at least one packaging unit width or part-width and/or height relative to the transport pallet (1) in a transverse direction component to the direction of extent of one of its transport legs.

### FIELD OF THE INVENTION

The invention relates to a palletising device and a method for populating transport pallets with packaging units in rows and/or columns, having the features of the preamble of claims 1 and 7. Accordingly, in order to populate transport pallets with packaging units in at least one position of packaging units, a feed apparatus is provided to bring the packaging units into the vicinity of the transport pallet and a delivery apparatus is provided for providing a transport pallet with the packaging units which have been brought in rows and/or columns.

### TECHNOLOGICAL BACKGROUND

Ready-packaged products, which are packed in bags, sacks or boxes or other containers, are placed in layers onto a transport pallet with the aid of a palletiser. In order to allow the delivery of the packaging units and the provision of the transport pallet with the packaging unit to proceed in an automated manner, a multiplicity of working steps are necessary. The product, generally the packaging units, is usually fed to the palletiser by means of conveyor belts or roller conveyors. The palletiser rotates and turns the product in a process-controlled manner, so that a dense layering on the pallet surface in at least one position is achieved. After “palletisation” is finished, the loaded pallet is intermediately stored or immediately transported further and where necessary provided with outer packaging beforehand. Outer packaging can mean, among other things, wrapping or shrink-wrapping film or fused plastic bags or any other type of outer packaging. The product is then ready for intermediate storage or transport.

During palletising, the packaging units have until now been collected one after the other in a row in the conveying direction of the feed apparatus. A complete row of packaging units is then pushed transversely to the feed direction onto an intermediate surface with a bolt or the like. Then the next row of packaging units is assembled and in turn pushed transversely as a complete row. The process is repeated until the loading surface of the transport pallet is used as completely as possible. Then the layer of packaging units created in rows and columns in this manner can be aligned again in itself. Suitable stops are used for this. Only then is the intermediate surface or roller situated under the layer of packaging units pulled out to the side, so that the stack layer is set down on a pallet situated underneath; the process therefore takes place overall as a batch operation and not in continuous operation, as would be desirable.

### PRESENTATION OF THE INVENTION

The invention is based on the problem of making continuous palletising possible with a generic palletising device. To solve this problem, a palletising device and a method having the features of claims 1 and 7 are proposed. Accordingly, it is provided for the delivery apparatus to comprise an endless conveying means, which is operated in a horizontal arrangement and consists of at least two conveyor runs which act as transport legs. The horizontally arranged endless conveying means can be moved as a whole by at least one packaging unit width and/or height with a transverse component to the direction of extent of one of its transport legs.

This makes it possible to feed the packaging units which are continuously received from the feed apparatus by the delivery apparatus, from a horizontal conveying path from a first conveyor run of the endless conveying means to a second conveyor run of the endless conveying means and to set down the packaging units in close succession directly on the transport pallet along the second conveyor run. With the aid of the displacement, which takes place with a transverse component (in relation to the second transport leg), of the endless conveying means as a whole by at least one packaging unit width or height, the assembly of a second stack row directly on the transport pallet can be started immediately after one stack row has been completed. This process is repeated until the desired pallet surface, in particular the entire pallet surface, is provided with the packaging units along its length and width. Then the endless conveying means with the delivery apparatus can be moved by at least one packaging unit height, and the same delivery process can be continued in a second layer of packaging units. In principle, however, it is also possible to stack up vertical layers of packaging units with the palletising device first and then form further vertical packaging layers. In this case, the endless conveying means is raised overall after completing a row of packaging units, in order to form the next layer of packaging units. For vertical stacking, the feed apparatus can be height-adjustable at least at its output end.

While it is in principle possible to choose the orientation of the feed section in relation to the direction of extent of the conveyor runs of the endless conveying means of the delivery apparatus freely, it is preferred if the direction of extent coincides as fully as possible with the transverse movement direction of the delivery apparatus. Among other things, this simplifies the continuous transfer of the conveyed packaging units by the delivery apparatus.

The transverse movement direction of the delivery apparatus to the transport leg providing the packaging units can in principle take place within a wide angular range, which in principle lies between 1° and 179°. If this angle is closer to 90°, in particular between 45° and 145° and very particularly preferably is 90°, the size of the system is particularly compact.

In principle it is sufficient if the endless conveying means has two conveyor runs. However, the horizontally arranged endless conveying means preferably forms a polygonal line consisting of more than two transport legs. Among other things, a certain conveying part-section of the feed apparatus can then run parallel to the run of the endless conveying means which receives the packaging units, which among other things makes it easier to synchronise the two movements and/or the alignment of the packaging units. A polygonal line of the endless conveying means which corresponds to the outline of the transport pallet, that is a rectangular polygonal line in many applications, is very particularly preferably selected. Deflection wheels or rolls are situated in a suitable deflection apparatus between the individual, in the last mentioned case four, transport legs of the endless conveying means.

It is now possible in various ways to transport the packaging units along the conveyor runs and around the deflections with the horizontally arranged endless conveying means. In principle it is possible to place the packaging units directly on the transport pallet by moving the packaging units on a substantially vertically oriented holding means, that is, in a laterally suspended manner. For the greatest possible flexibility in placing the packaging units, it is however preferred if the holding means for suspended transport of the packaging units have a substantially horizontal alignment, so that the packaging unit is transported in a suspended manner under the holding means. A wide variety of means for suspended transport can be used for this, such as grippers, suction devices, electromagnets and others. This makes it possible among other things to transfer the packaging units in an arrangement lying on the feed apparatus in a simple manner, namely from horizontal transport to suspended transport. If packaging units of different heights are to be stacked on the same or different transport pallets, an ability to change the height of the feed apparatus and/or of the horizontal endless conveying means can be provided. Such an ability to change height is also advantageous for stacking packaging units in several layers on top of each other. With suspended transport stops, which can be adjustable if necessary, can also be used for different positioning of the packaging units in relation to the horizontal endless conveying means. Such stops can also improve securing of the position, in particular securing against tilting of the packaging unit during transport along the conveyor run. In principle, such stops can also be provided in a gripping manner in a movable or rigid arrangement under the packaging units. This increases transport security and/or the range of permissible packaging unit weights which can be palletised, among other things. In principle, a vertically or horizontally suspended transport is not absolutely necessary.

The components to be used according to the invention which are mentioned above, as well as those claimed and described in the exemplary embodiments, are not subject to any special exceptional conditions in terms of their size, shape, material and technical design, so the selection criteria known in the field of application can be used without restriction.

Further details, features and advantages of the subject matter of the invention can be found in the subclaims and in the following description and the associated drawing, in which an exemplary embodiment of a palletising device for populating transport pallets with packaging units in rows and/or columns is shown by way of example. Individual features of the claims or of the embodiments can also be combined with other features of other claims and embodiments.

### BRIEF DESCRIPTION OF THE FIGURES

In the drawing,

FIG. 1 shows work sequences a) to h) of a palletising device for populating (providing) a transport pallet with packaging units in a dense arrangement, in each case in a plan view and in a left side view (to the right), and

FIG. 2 shows a holding means for vertically suspended transport of packaging units with an endless conveying means in a horizontal arrangement.

### DETAILED DESCRIPTION OF EXEMPLARY EMBODIMENTS

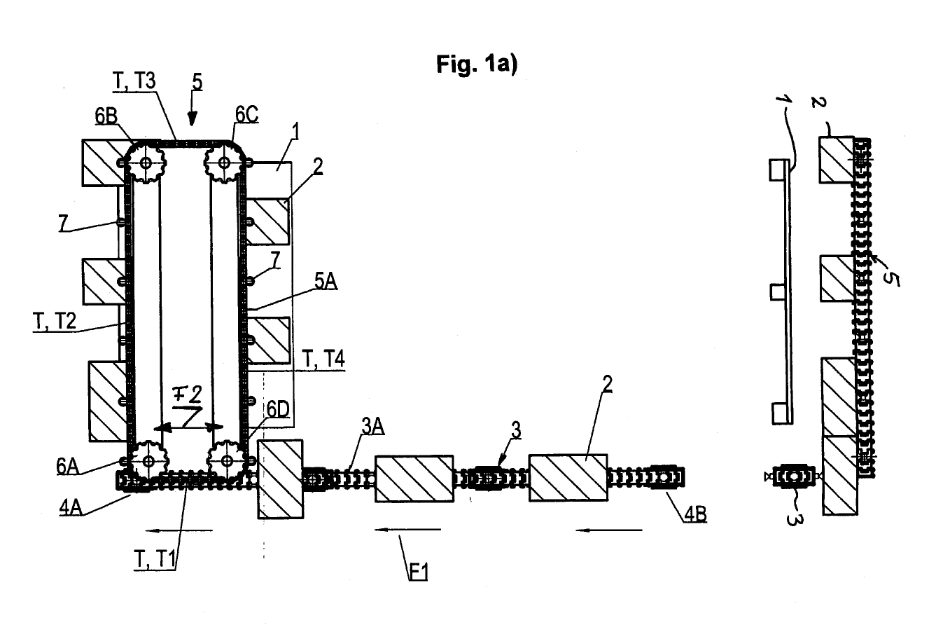

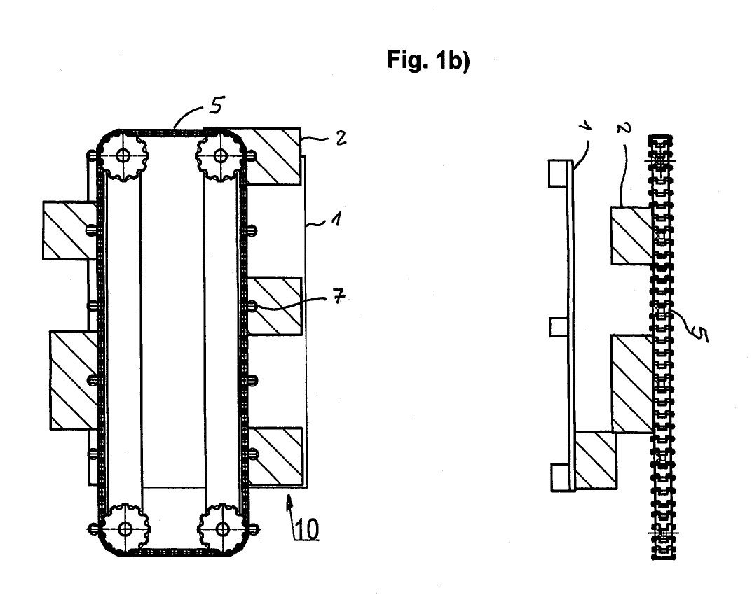

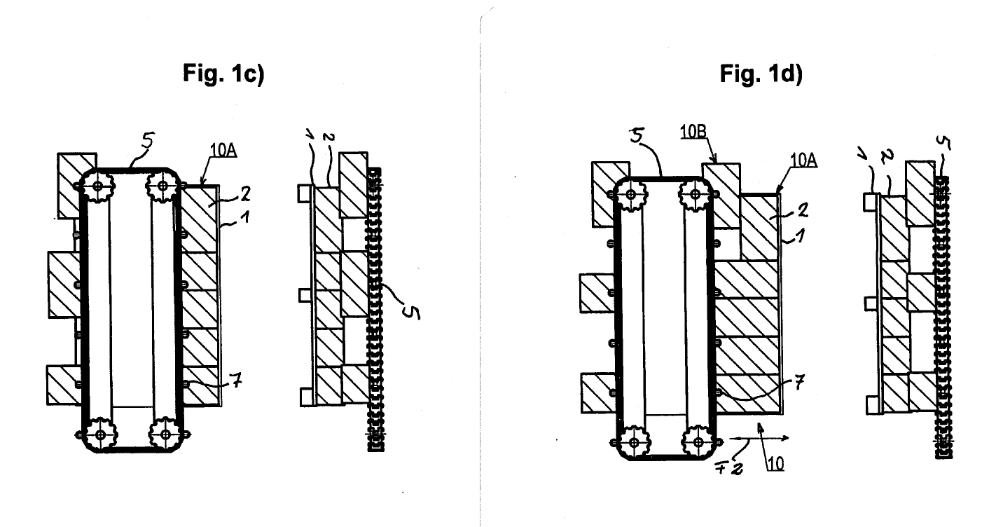

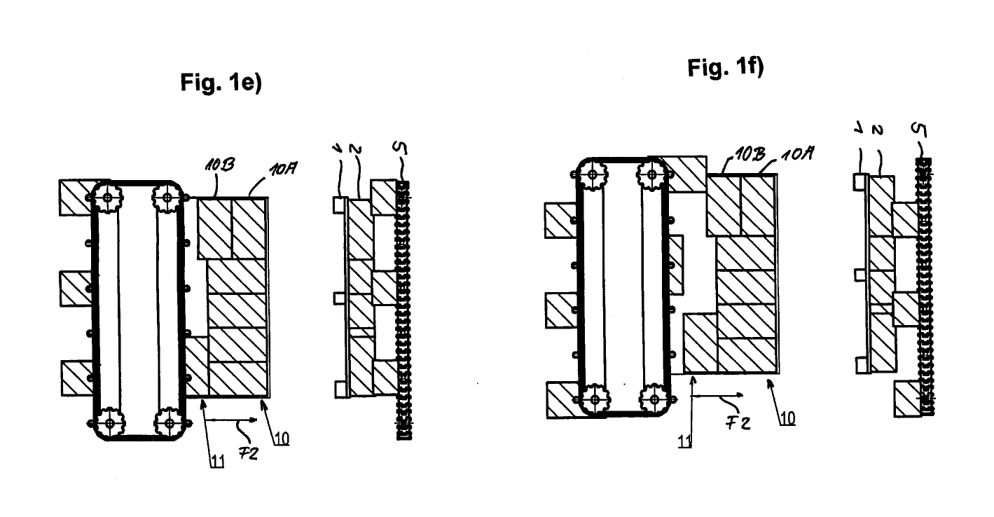

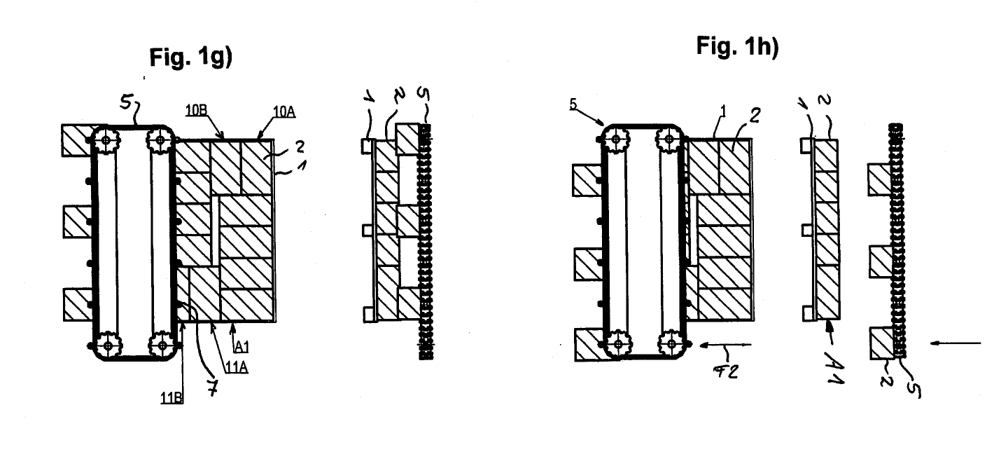

The palletising device is explained in more detail viewed from above and in a left side view using the example of working position a) in FIG. 1. A transport pallet 1 is to be provided continuously with packaging units 2 of approximately the same height but differently sized outlines and different alignments. To this end, a feed apparatus 3 in the form of an endless conveying means is provided, which can consist of a multiplicity of chain links, which can be pivoted with each other and form a (constantly) circulating transport chain, and is deflected by 180° in the region of deflection apparatus 4A, 4B, the packaging units 2 being transported in a first conveying direction F1 lying on what is known as the upper run 3A.

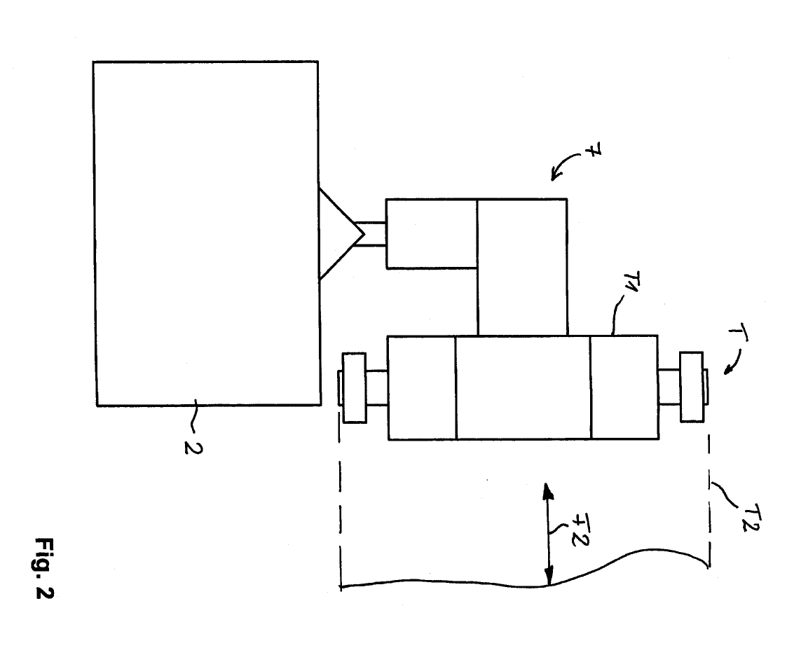

Above the transport pallet 1 there is a delivery apparatus 5, which is configured as a polygonal line of rectangular shape. An endless conveying means 5A, which like the feed apparatus 3 is guided around deflection apparatuses 6A-6D with vertical rotation axes and in particular can be driven at the deflection apparatuses, is equipped with holding means 7, which allow downwardly suspended transport of the packaging units 2 (see FIG. 2). Accordingly, the transport plane during feeding is situated slightly below the delivery apparatus 5, as can be seen in particular in sequence picture h).

The provision of the transport pallet 1 with packaging units 2 now proceeds in such a manner that first the successive packaging units 2 are placed directly on the transport pallet 1 closely to each other in a first row 10 or half-row 10A—see sequence picture b—until the state show in sequence picture c) is achieved. As can be seen from sequence picture d), the packaging unit which has been added to the first stack (half-)row 10A last is narrower than the others and arranged transversely to them in order to use the stacking surface in the best possible manner. Accordingly, the first stack row 10 can still be populated with a second transversely oriented packaging unit in this region (stack half-row 10B). Therefore, as can be seen by comparing sequence pictures c) and d), a relative movement between the transport pallet 1 and the delivery apparatus 5 is executed parallel to the first conveying direction F1. Then, to populate a second stack row 11, a further relative movement between the transport pallet 1 and the delivery apparatus 5 is executed and the second stack row 11 is provided. The feed flow of the further packaging units has been omitted in sequence pictures b) to h) for the sake of clarity. To be able to provide the second stack row 11 with packaging units positioned adjacently to each other, the relative movement between the transport pallet 1 and the delivery apparatus 5 can be continued for this purpose, as can be seen by comparing sequence picture e) with sequence picture f). It can be seen from sequence picture b) how the first layer of packaging units fills the transport pallet with optimal utilisation of area. Then follows a further relative movement between the transport pallet 1 and the delivery apparatus 5 in such a manner that now a further layer of packaging units can be stacked above the packaging units of the first stack row 10, 10A, 10B. This relative movement is not yet completed in sequence picture h), as can be seen.

In the preferred exemplary embodiment shown, one of the transport legs T, that is the conveyor run T1 of the endless conveying means 5A in the exemplary embodiment, therefore runs parallel to the feed direction of the feed apparatus 3, that is, parallel to the first conveying direction F1.

### LIST OF REFERENCE SYMBOLS

1 Transport pallet
2 Packaging units
3 Feed apparatus
3A Upper run
4A Deflection apparatus
4B Deflection apparatus
5 Delivery apparatus
5A Endless conveying means
6A-6D Deflection apparatuses
7 Holding means
10 First stack row
10A Half-row
10B Half-row
Second stack row
11A Half-row
11B Half-row
A1 First position
F1 First conveying direction
F2 Transverse movement direction
T Transport leg
T1-4 Conveyor run

1. A palletizing device for populating transport pallets with packaging units in rows and/or stacks in at least one layer of packaging units, having a feed apparatus for bringing the packaging units into the vicinity of the transport pallet and having a delivery apparatus for providing a transport pallet with the packaging units brought,
characterised in that
the delivery apparatus comprises an endless conveying means,
the endless conveying means comprises at least two conveyor runs acting as transport legs in a horizontal arrangement and that
the horizontally arranged endless conveying means as a whole can be moved by at least one packaging unit width or part-width and/or height relative to the transport pallet in a transverse direction component to the direction of extent of one of its transport legs.

2. The palletizing device according to claim 1, characterised in that the first conveying direction of the feed device is aligned parallel to a transverse movement direction of the delivery apparatus in relation to the transport pallet.

3. The palletizing device according to claim 1, characterised in that holding means for the vertically suspended transport of the packaging units are provided on the horizontally arranged endless conveying means.

4. The palletizing device according to claim 1, characterised in that the endless conveying means form a horizontal polygonal line consisting of a plurality of transport legs.

5. The palletizing device according to claim 4, characterised in that the endless conveying means form a rectangular polygonal line.

6. The palletizing device according to claim 1, characterised in that the transverse movement direction forms an angle selected from the group consisting of between 1°and 179°, between 45°and 135°, and a right angle with the transport leg which is used to place the packaging units on the transport pallet.

7. A method for populating transport pallets with packaging units in rows and/or columns in at least one layer of packaging units, having a feed apparatus for bringing the packaging units into the vicinity of the transport pallet and having a delivery apparatus for providing the transport pallet with the packaging units brought, characterised in that the packaging units are received continuously from the feed apparatus by means of a horizontally arranged endless conveying means and placed directly on the transport pallet along one of a plurality of conveyor runs of the endless conveying means, forming a densely packed row of packaging units, and that the horizontal endless conveying means as a whole is moved relative to the transport pallet in order to provide a further row with packaging units in a transverse direction to the orientation of the already populated row/rows of packaging units.

8. The palletizing device according to claim 2, characterized in that holding means for the vertically suspended transport of the packaging units are provided on the horizontally arranged endless conveying means.

9. The palletizing device according to claim 8, characterized in that the endless conveying means form a horizontal polygonal line consisting of a plurality of transport legs.

10. The palletizing device according to claim 9, characterized in that the endless conveying means form a rectangular polygonal line.

11. The palletizing device according to claim 10, characterized in that the transverse movement direction forms an angle selected from the group consisting of between 1°and 179°, between 45°and 135°, and a right angle with the transport leg which is used to place the packaging units on the transport pallet.
